(19) United States
(12) Patent Application Publication
(10) Pub. No.: US 2024/0380852 A1
(43) Pub. Date: Nov. 14, 2024

(54) IMAGE PROCESSING SYSTEM, IMAGE PROCESSING METHOD, AND NON-TRANSITORY COMPUTER READABLE MEDIUM

(71) Applicant: FUJIFILM Business Innovation Corp., Tokyo (JP)

(72) Inventor: Takeshi KANEKO, Kanagawa (JP)

(73) Assignee: FUJIFILM Business Innovation Corp., Tokyo (JP)

(21) Appl. No.: 18/502,151

(22) Filed: Nov. 6, 2023

(30) Foreign Application Priority Data
May 8, 2023 (JP) 2023-076653

(51) Int. Cl. H04N 1/00; H04N 1/32

(52) U.S. Cl. CPC H04N 1/00652; H04N 1/00769; H04N 1/3263

(57) ABSTRACT

An image processing system includes one or more processors configured to, when a document as a scanning target travels and concurrently an image of the document being scanned in is formed on a medium, issue an instruction to start formation of the image on the medium after a transport distance traveled by the document or an elapsed time exceeds a threshold after scanning of the document starts, the threshold being set as a distance or a period for stabilizing transport of the document.

### CROSS-REFERENCE TO RELATED APPLICATIONS

This application is based on and claims priority under 35 USC 119 from Japanese Patent Application No. 2023-076653 filed May 8, 2023.

### BACKGROUND

### (i) Technical Field

The present disclosure relates to an image processing system, an image processing method, and a non-transitory computer readable medium.

### (ii) Related Art

An operation mode is available in which a document as a scanning target is traveling and concurrently an image of the document being scanned in is formed on a sheet (also referred to as a “medium” hereinafter). This operation mode is adopted in view of enhancing productivity to reduce a time period between the start of scanning a document having a maximum length and the end of forming the image of the document, that is, to reduce a time period necessary for copying the document having a maximum length (referred to as a “maximum processing time period” hereinafter). Japanese Unexamined Patent Application Publication No. 8-97991 is an example of related art.

### SUMMARY

A document of a greater size in the transport direction is known to be more likely to cause document jamming during transport than a document of a smaller size in the transport direction. This is because a document of a greater size in the transport direction is likely to cause a skew during transport. Thus, when the image of a document is recorded on a medium, a document of a greater size in the transport direction is more likely to generate a wasted medium than a document of a smaller size in the transport direction.

Aspects of non-limiting embodiments of the present disclosure relate to achieving less amount of wasted medium due to document jamming than in a case of determining the time to start the formation of an image on a medium in view of minimizing the maximum processing time period when the formation is performed concurrently with scanning a document in.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing system including one or more processors configured to, when a document as a scanning target travels and concurrently an image of the document being scanned in is formed on a medium, issue an instruction to start formation of the image on the medium after a transport distance traveled by the document or an elapsed time exceeds a threshold after scanning of the document starts, the threshold being set as a distance or a period for stabilizing transport of the document.

### BRIEF DESCRIPTION OF THE DRAWINGS

Exemplary embodiments of the present disclosure will be described in detail based on the following figures, wherein:

FIG. 1 depicts an example of a system configuration of an image processing system according to a first exemplary embodiment;

FIG. 2 depicts an example of a functional configuration of a processor;

FIG. 3 is an illustration describing a waiting period for which the formation, on a sheet, of an image corresponding to image data ends at the same time as the scanning of a predetermined maximum document length ends;

FIG. 4 is an illustration describing a waiting period for reducing, for example, the amount of sheet wasted due to document jamming;

FIG. 5 is a flowchart for describing an example of a processing operation performed by the image processing system when a user instructs the image processing system to perform copying;

FIG. 6 is an illustration describing a relationship between the transport distance traveled by a document and the transport distance traveled by a sheet when T0≥Ts;

FIG. 7 is an illustration describing a relationship between the transport distance traveled by a document and the transport distance traveled by a sheet when S≥L;

FIG. 8 is an illustration describing an example of a user interface screen used to set a distance for stabilizing document transport;

FIG. 9 is an illustration describing a change in the user interface screen that appears when a distance for stabilizing document transport is inappropriately specified;

FIG. 10 is a flowchart for describing an example of a processing operation performed by the image processing system when a user instructs the image processing system to perform copying;

FIG. 11 is an illustration describing an example of a database that has collected histories of document jamming that occurred in the past;

FIG. 12 is an illustration describing an example of a user interface screen used to set a waiting period for stabilizing document transport; and

FIG. 13 is an illustration describing an example of a system configuration of an image processing system according to another exemplary embodiment.

### DETAILED DESCRIPTION

Hereinafter, exemplary embodiments of the present disclosure will be described with reference to the drawings.

### First Exemplary Embodiment

### System Configuration

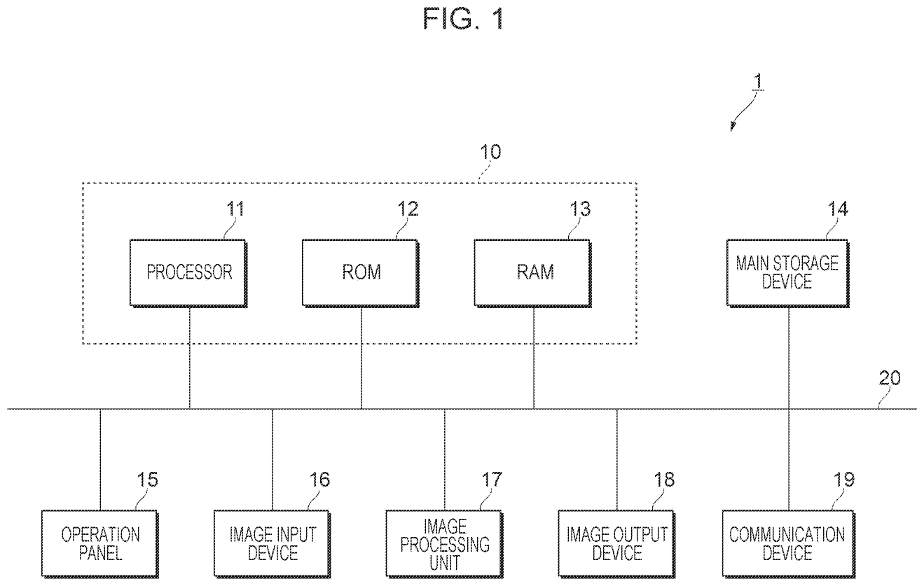

FIG. 1 depicts an example of a system configuration of an image processing system 1 according to a first exemplary embodiment.

The image processing system 1 according to the first exemplary embodiment has a print function, a scan function, and a copy function. The print function refers to a function of forming an image corresponding to image data on a sheet. The scan function refers to a function of scanning a document in to acquire image data. A document is an example of a scanning target. The copy function causes the print function to form, on a sheet, an image corresponding to image data acquired by the scan function.

The image processing system 1 according to the first exemplary embodiment includes a controller 10 configured to control the entire system, a main storage device 14 configured to store images to be processed and operation screens, an operation panel 15 used to display operation screens and accept user operations, an image input device 16 configured to optically scan in document images, an image processing unit 17 configured to perform predetermined processing on image data to be processed, an image output device 18 configured to form an image on a sheet as a recording medium, and a communication device 19 used to communicate with external apparatuses. The controller 10 is connected to the other devices using a signal line 20, such as a bus line connecting each device.

The controller 10 is formed of a processor 11 configured to execute programs, a read only memory (ROM) 12 configured to store programs, such as a basic input/output system (BIOS) and firmware, and data, and a random access memory (RAM) 13 used as a work area for the programs. The controller 10 operates as a so-called computer.

The main storage device 14 is formed of, for example, a hard disk device or a semiconductor memory. The hard disk device and the semiconductor memory are examples of a recording medium.

The operation panel 15 is formed of, for example, a touch panel and hardware components such as a button and a switch.

The touch panel is formed of, for example, a display device and a film sensor of electrostatic capacitance type. The film sensor of electrostatic capacitance type is formed of a highly transparent material allowing the visibility of the display device and is attached to the display surface of the display device. The display device is formed of, for example, a liquid crystal display or an organic electroluminescence (EL) display.

The image input device 16 is a so-called scanner. The image input device 16 according to the present exemplary embodiment includes a transport mechanism, an illuminating light source, and an image sensor; the transport mechanism, such as a transport roller, is configured to transport a document placed in or on a document tray; the image sensor is configured to scan in a document during transport to acquire image data.

The illuminating light source is configured to illuminate a document during transport with a line-shaped illuminating light beam. In the present exemplary embodiment, the position illuminated with the illuminating light beam is referred to as a scanning position. The scanning position in the present exemplary embodiment is fixed.

Examples of the image sensor to be used include a charge coupled device (CCD) and a contact image sensor (CIS). The image input device 16 according to the present exemplary embodiment supports, for example, all of the full color format, the gray scale format, and the black-and-white format as the output format of image data acquired from a scanned document.

The image input device 16 according to the present exemplary embodiment scans a document in sheet by sheet. Specifically, the image input device 16 displays or saves image data every time image data is acquired by scanning one-sheet document in.

The image input device 16 according to the present exemplary embodiment may acquire image data by scanning in a document of any size that satisfies a predetermined criterion regarding the maximum width and length as well as of fixed sizes such as A0, A1, A2, A3, and A4. The maximum width is approximately 1 m, and the maximum length is approximately 16 m. When copying a document having such a large maximum length (that is, a large feed length), a user has to wait for a long time until the copying ends if printing the document on a sheet starts after the entire length of the document has been scanned in.

Thus, as described above, a synchronous copying mode is provided in which printing starts while a document is being scanned in and thus a time difference between the end of scanning the document in and the end of printing is reduced. The synchronous copying mode is an example of a mode for prioritizing productivity.

Additionally, a minimum thickness and a maximum thickness are specified for a document that may be scanned in by the image input device 16. For example, the minimum thickness is approximately 0.2 mm, and the maximum thickness is approximately 13 mm. The thickness of a document may be identified, for example, by reading or detection of the position of a lever for adjusting the thickness.

Further, the image input device 16 according to the present exemplary embodiment supports multiple scanning speeds. A user may switch between the scanning speeds before starting to scan a document in. In the present exemplary embodiment, it is assumed that three levels, “High Speed”, “Middle Speed”, and “Low Speed” are available. The term “Middle Speed” represents a speed approximately half the speed represented by the term “High Speed”, and the term “Low Speed” represents one third of the speed represented by the term “Middle Speed”. These speed ratios are provided as an example.

The image processing unit 17 is configured to perform preliminary processes including, for example, level correction and processes for improving image quality. Examples of the processes related to image quality include density, sharpness, contrast, and ground color removal.

The image output device 18 is configured to print images on the surfaces of rolled paper or a cut sheet with, for example, an electrophotographic system or an inkjet system.

In the present exemplary embodiment, it is assumed that cut sheets of A0, A1, A2, A3, and A4 sizes and rolled paper having a predetermined width and rolled into a predetermined diameter are used. The width and length of a sheet to be manually fed are determined in advance. The size of a sheet is not limited to the above examples.

The communication device 19 is configured to communicate with external apparatuses, such as a server, a computer, and a storage device, connected to the network, for example, via an Ethernet (registered trademark) network.

### Functional Configuration

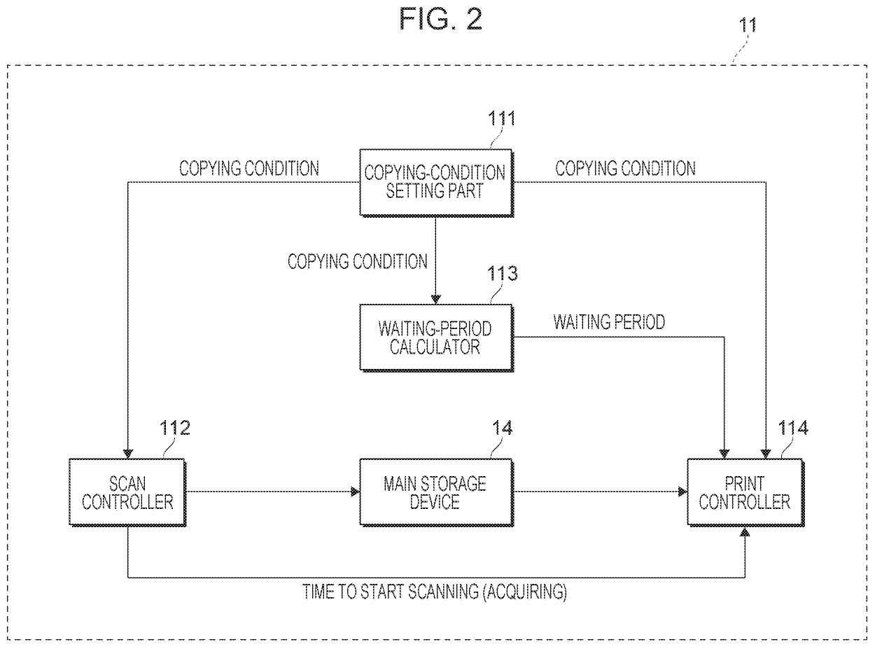

FIG. 2 depicts an example of a functional configuration of the processor 11. Each component in FIG. 2 having a corresponding component in FIG. 1 is denoted by the same numeral as in FIG. 1.

The functional units depicted in FIG. 2 are implemented by the execution of programs. FIG. 2 only depicts units that are related to the copy function among the functional units implemented by the processor 11.

FIG. 2 depicts as typical functions a copying-condition setting part 111, a scan controller 112, a waiting-period calculator 113, and a print controller 114.

The copying-condition setting part 111 is a functional unit configured to set a copying condition specified using the operation panel 15. Examples of a copying condition include a fixed-size copying mode in which the output size is fixed to a specified size, a synchronous copying mode in which document scanning and image formation concurrently proceed, a distance S for stabilizing document transport, a sheet size, a discharge port, necessity of a postprocess, and postprocessing details.

In the present exemplary embodiment, the distance S for stabilizing document transport is set to an initial value prior to shipment from the factory. The distance S for stabilizing document transport as used herein is determined, for example, based on the maximum value selectable in the image input device 16 as the transport speed of a document. Thus, in the present exemplary embodiment, a user does not need to specify the distance S as a copying condition. The distance S herein is an example of a threshold.

The scan controller 112 is a functional unit configured to control scanning in a document in the image input device 16 (refer to FIG. 1). Specifically, in response to detection that a document feeder is loaded with a document or a document is inserted into the document feeder, the scan controller 112 instructs the image input device 16 to transport the document and acquire image data.

Prior to the transport of the document, the scan controller 112 informs the image input device 16 of data such as a transport speed reported by the copying-condition setting part 111.

Additionally, after having informed the image input device 16 of data such as the transport speed, the scan controller 112 instructs the image input device 16 to start scanning the document in to acquire image data of the document.

The print controller 114 is notified of the time to start scanning (acquiring) via the scan controller 112. In response to the notification, the print controller 114 starts to measure the waiting period.

Additionally, the scan controller 112 controls saving to the main storage device 14 image data of the document scanned in by the image input device 16.

The waiting-period calculator 113 is a functional unit configured to calculate a waiting period between the start of scanning a document in to acquire image data and the start of printing the image data in accordance with the copying condition accepted by the copying-condition setting part 111.

Specifically, the waiting-period calculator 113 is configured to set the waiting period to be used in the fixed-size copying mode and the synchronous copying mode. When the waiting period has elapsed after the time to start scanning, image formation on a sheet starts. In other words, sheet transport starts.

In this way, the waiting period is used to determine the “time to start printing”.

In the present exemplary embodiment, the waiting periods are generally classified into two types.

A first type is a waiting period T0 for which the formation, on a sheet, of an image corresponding to image data ends at the same time as the scanning of a predetermined maximum document length L ends. In other words, the waiting period T0 provides the time to start printing such that the time to finish scanning the document in to acquire the image data coincides with the time to finish forming the image on the sheet. The waiting period T0 is calculated using the maximum document length L, a document transport speed Si, and a sheet transport speed So.

A second type is a waiting period Ts necessary for the document to travel the distance S for stabilizing document transport. The waiting period Ts is calculated using the distance S for stabilizing document transport and the document transport speed Si.

The waiting period T0 and the waiting period Ts herein are examples of an elapsed time after the time to start scanning the document in. The waiting period T0 and the waiting period Ts are also examples of a threshold.

The print controller 114 is a functional unit configured to control the output of image data stored in the main storage device 14 to the image processing unit 17 and the image output device 18 (refer to FIG. 1).

The print controller 114 is notified, by the waiting-period calculator 113, of a waiting period between the time to start scanning and the time to start printing. The print controller 114 starts to monitor for a lapse of the waiting period in response to the notification of the time to start scanning received from the scan controller 112. After confirming that the waiting period has elapsed, the print controller 114 starts to form on a sheet an image corresponding to the image data retrieved from the main storage device 14.

### Description of Waiting Period

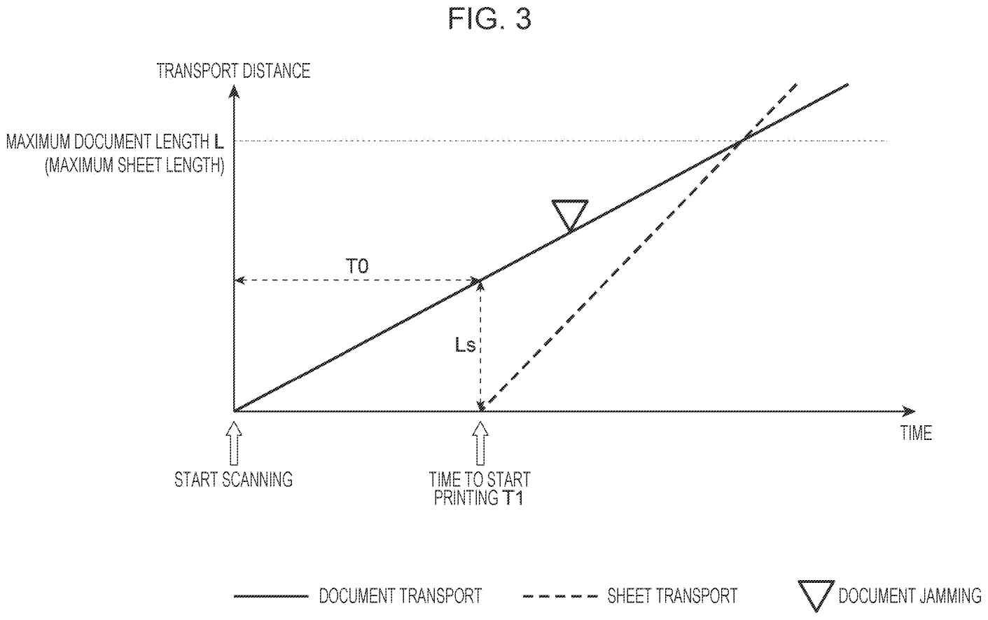

FIG. 3 is an illustration describing the waiting period T0 for which the formation, on a sheet, of an image corresponding to image data ends at the same time as the scanning of a predetermined maximum document length L ends. The horizontal axis represents time, and the vertical axis represents a transport distance. The time to start scanning a document in to acquire image data is defined as the origin.

In FIG. 3, the relationship between the transport distance traveled by the document and the time is represented by a solid line, and the relationship between the transport distance traveled by the sheet and the time is represented by a dashed line.

In the present exemplary embodiment, the transport speed of the sheet is faster than the transport speed of the document. Thus, the slope of the dashed line is larger than the slope of the solid line.

In FIG. 3, the solid line representing the transport distance traveled by the document crosses the dashed line representing the transport distance traveled by the sheet at the time that the solid line reaches the maximum document length L and the dashed line reaches the maximum sheet length.

The time to start printing T1 coincides with the waiting period T0 in this situation. The transport distance traveled by the document during the waiting period T0 is denoted by Ls.

Additionally, the time that document jamming occurs is represented by a triangle pointing downward in FIG. 3. The document jamming occurs later than the waiting period TO. In other words, sheet transport has already started when the document jamming occurs.

If document jamming occurs, the document needs to be scanned in again from the beginning to acquire image data, and a sheet on which an image has already been formed is to be discarded. Naturally, toner or ink that has been consumed for printing before the document jamming is wasted.

To avoid a sheet wasted due to document jamming, the formation of an image on a sheet may start after the entire document has been scanned in. However, this remedy goes against the intention of implementing the synchronous copying mode.

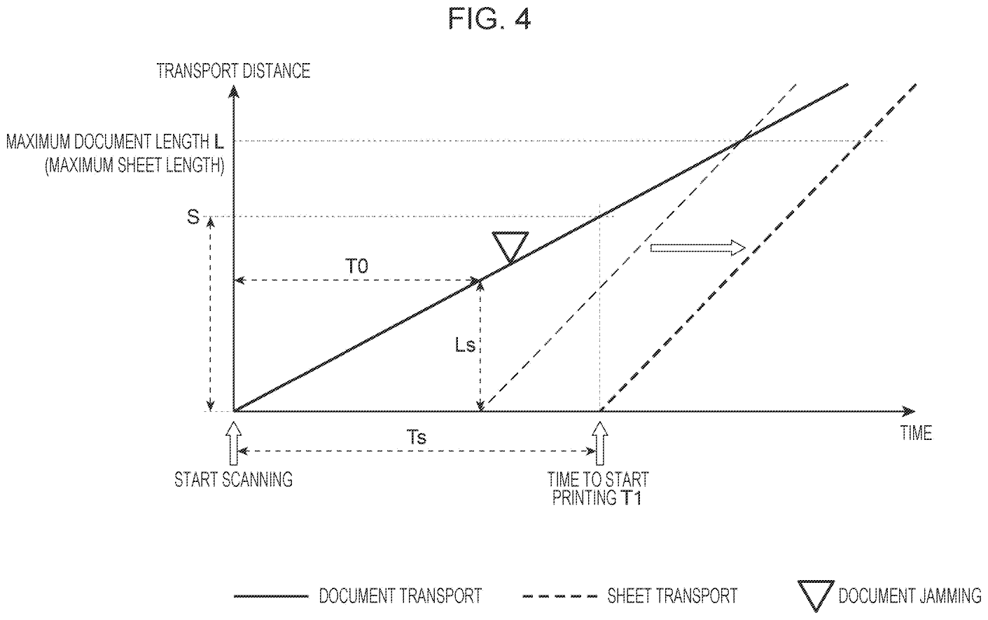

FIG. 4 is an illustration describing the waiting period Ts for reducing, for example, the amount of sheet wasted due to document jamming. The same symbols are used in FIGS. 3 and 4 to refer to corresponding portions and features.

It is known that document jamming during document transport is likely to occur immediately after the document transport begins for a document having a great length in the transport direction, and it is also known that document jamming becomes increasingly unlikely to occur as the transport distance increases.

In FIG. 4, the formation of an image on a sheet starts after the document has traveled the distance S (>Ls) for stabilizing document transport (that is, after the period Ts (>T0) corresponding to the distance S has elapsed).

In FIG. 4, document jamming has also occurred during document transport. However, the document jamming has occurred before the document travels the distance S for stabilizing document transport in FIG. 4. In other words, the document jamming has occurred before the time to start printing T1.

Thus, image formation on a sheet has not started. In this case, the occurrence of document jamming wastes neither a sheet nor toner or ink as recording material.

### Description of Processing Operation

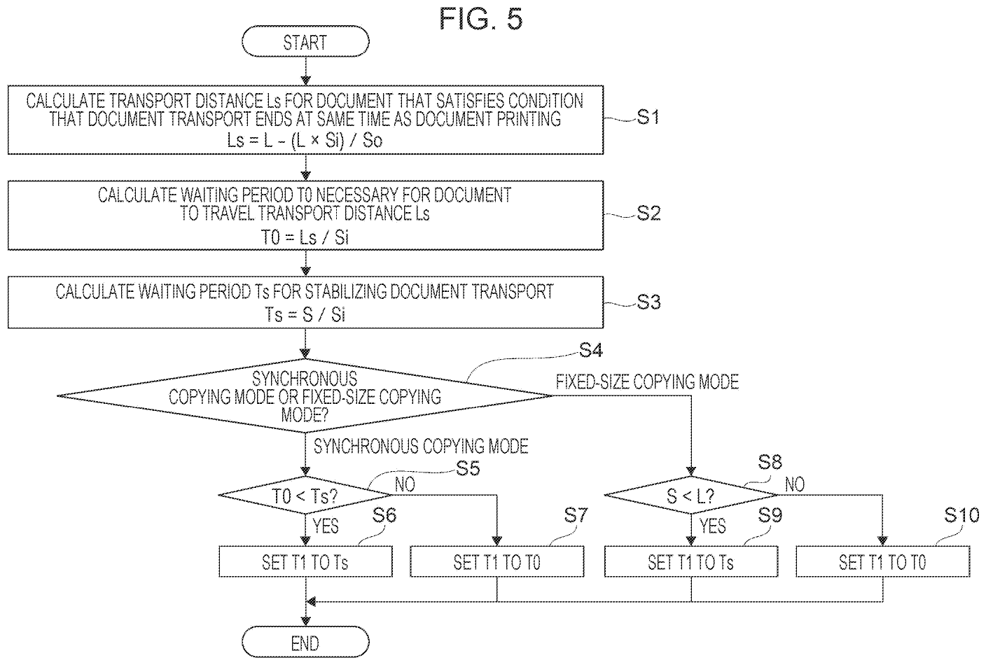

FIG. 5 is a flowchart for describing an example of a processing operation performed by the image processing system 1 (refer to FIG. 1) when a user instructs the image processing system 1 to perform copying. The processing operation depicted in FIG. 5 is achieved through the execution of programs by the processor 11 (refer to FIG. 1). The character “S” in FIG. 5 represents a step.

First, the processor 11 calculates, for a document, the transport distance Ls that satisfies a condition that the document transport ends at the same time as the printing ends (step 1). The transport distance Ls is depicted in FIGS. 3 and 4.

The transport distance Ls is calculated using the following equation:

Ls=L−(Lx Si)/So, Equation1
where L denotes the maximum document length, Si denotes the transport speed of the document, and So denotes the transport speed of the sheet.

Next, the processor 11 calculates the period T0 necessary for the document to travel the transport distance Ls (step 2). The period T0 is depicted in FIGS. 3 and 4.

The period T0 is calculated using the following equation:

T0=Ls/Si. Equation2

Once the period T0 is calculated, the processor 11 calculates the period Ts for stabilizing document transport (step 3).

To calculate the period Ts, information regarding the distance S for stabilizing document transport is necessary. In the present exemplary embodiment, the processor 11 uses a single distance S regardless of a category accepted as the transport speed of a document (for example, represented by the terms “High Speed”, “Middle Speed”, and “Low Speed”) in a copying condition.

The period Ts is calculated using the following equation:

Ts=S/Si. Equation3

As described above, Si denotes the transport speed of the document.

Next, the processor 11 determines which of the synchronous copying mode or the fixed-size copying mode has been selected (step 4).

If it is determined in step 4 that the synchronous copying mode has been selected, the processor 11 determines whether TO is less than Ts (step 5). In other words, the processor 11 determines whether the waiting period TO, which satisfies the condition that the document transport ends at the same time as the printing ends, is shorter than the waiting period Ts necessary for the document to travel the distance for stabilizing document transport.

If an affirmative determination is made in step 5 (that is, the relationship in FIG. 4 is satisfied), the processor 11 sets the time to start printing T1 to the waiting period Ts (step 6).

In this case, the processor 11 starts transporting the sheet at the time that the document has traveled the distance S for stabilizing document transport. Since the probability of occurrence of document jamming is low after the document has traveled the distance S for stabilizing document transport, the amount of sheet wasted due to document jamming is reduced.

In contrast, if a negative determination is made in step 5, the processor 11 sets the time to start printing T1 to the waiting period T0 (step 7).

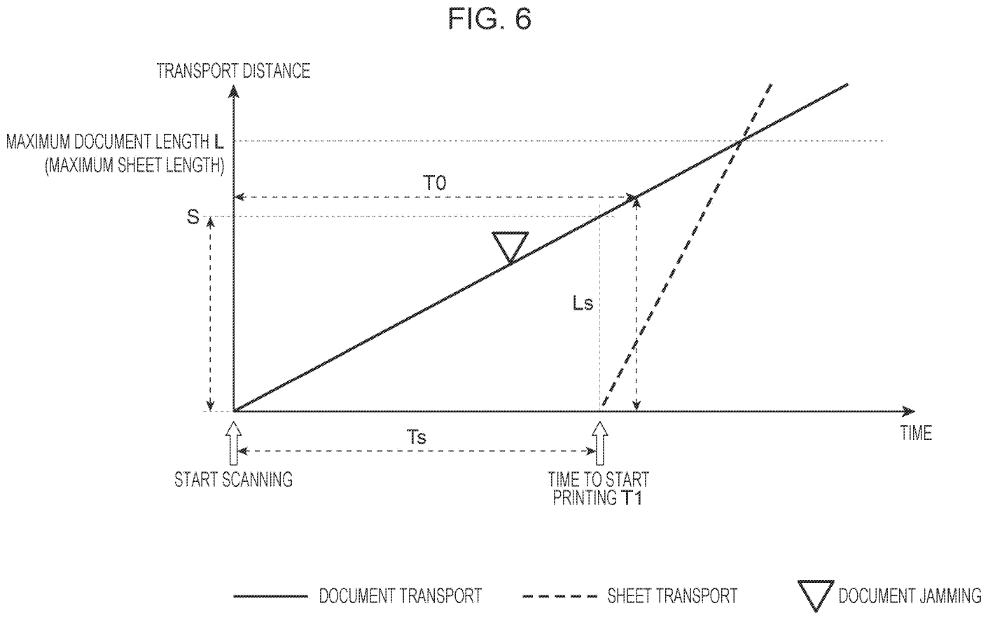

FIG. 6 is an illustration describing a relationship between the transport distance traveled by the document and the transport distance traveled by the sheet when T0≥Ts. The same symbols are used in FIGS. 4 and 6 to refer to corresponding portions and features.

In FIG. 6, the time to start printing T1 comes later than the waiting period Ts for stabilizing document transport. Thus, document jamming is unlikely to occur later than the time to start printing T1. In addition, if the sheet transport starts at the time to start printing T1, the document transport ends at the same time as the printing ends.

Next, description will be given with regard to a case where it is determined in step 4 that the fixed-size copying mode has been selected. In the fixed-size copying mode, an image provided by the image data acquired from the document is enlarged or reduced before printing so as to fit a specified sheet size. For example, a document of the A2 size is enlarged before printing to fit a sheet of the A1 size.

The size of a document as a scanning target is determined based on the direction of the document specified using the operation panel 15 (refer to FIG. 1) and the detection result of the width of the document inserted into the document feeder.

In this case, the processor 11 determines whether S is less than L (step 8). In other words, the processor 11 determines whether the distance S for stabilizing document transport is less than the maximum document length L.

If an affirmative determination is made in step 8 (that is, the relationship in FIG. 4 is satisfied), the processor 11 sets the time to start printing T1 to the waiting period Ts (step 9).

In this case, the processor 11 starts transporting the sheet at the time that the document has traveled the distance S for stabilizing document transport.

In contrast, if a negative determination is made in step 8, the processor 11 sets the time to start printing T1 to the waiting period T0 (step 10).

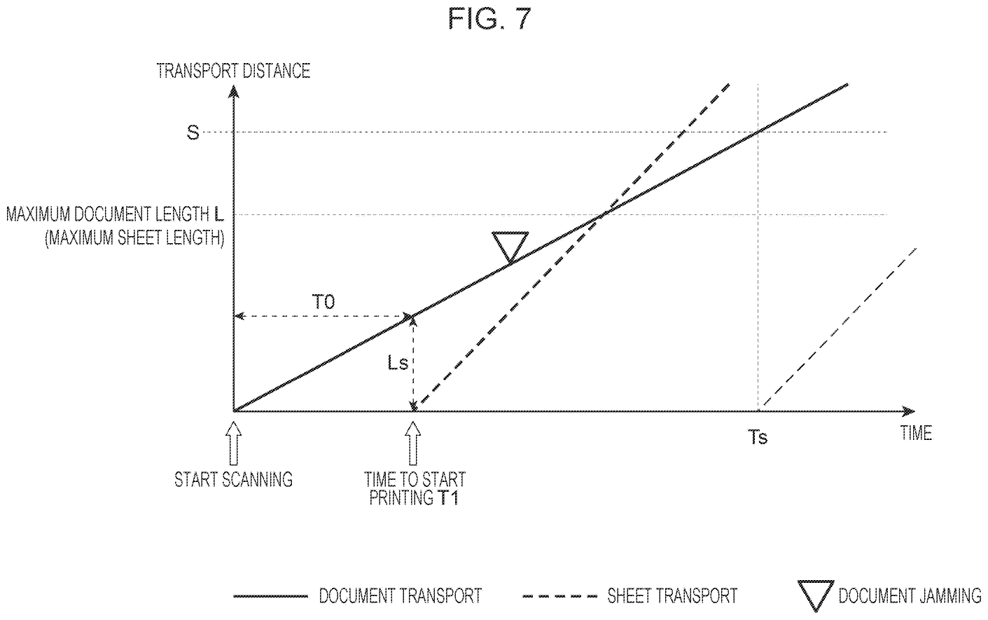

FIG. 7 is an illustration describing a relationship between the transport distance traveled by the document and the transport distance traveled by the sheet when S≥L. The same symbols are used in FIGS. 6 and 7 to refer to corresponding portions and features.

In FIG. 7, the time to start printing T1 comes earlier than the waiting period Ts for stabilizing document transport. Thus, document jamming may occur later than the time to start printing T1.

However, if the sheet transport starts at the waiting period Ts for stabilizing document transport, printing does not start even after the document transport ends. Unfortunately, this operation leads to a decrease in productivity.

Thus, productivity is prioritized in the fixed-size copying mode in the present exemplary embodiment, rather than delaying the start of the sheet transport (that is, copying output) to avoid document jamming. Since a document for which a negative determination is made in step 8 has a short length in the transport direction, document jamming is relatively unlikely to occur. This is another reason that the time to start printing T1 is set to the waiting period T0 if a negative determination is made in step 8.

### Summarization

In the present exemplary embodiment, since sheet transport starts (that is, printing starts) after the period Ts for stabilizing document transport has elapsed in the synchronous copying mode, the amount of wasted medium due to document jamming may be reduced while productivity is prioritized.

In the fixed-size copying mode, if the maximum document length L is less than the distance S for stabilizing document transport, since sheet transport starts (that is, printing starts) after the period Ts for stabilizing document transport has elapsed as in the synchronous copying mode, the amount of wasted medium due to document jamming may be reduced while productivity is prioritized.

Furthermore, in the fixed-size copying mode, if the maximum document length L is more than the distance S for stabilizing document transport, since sheet transport starts (that is, printing starts) so that the document transport ends at the same time as the printing ends, the sheet transport need not start after the document transport ends. In summary, a decrease in productivity may be avoided.

### Second Exemplary Embodiment

In the present exemplary embodiment, the image processing system 1 described with reference to FIG. 1 is also assumed. A processor 11 used in the present exemplary embodiment (refer to FIG. 1) also has the functional configuration depicted in FIG. 2.

However, an image processing system 1 according to the present exemplary embodiment has a capability of setting the distance S for stabilizing document transport via a screen operation. In other words, in the present exemplary embodiment, the distance S may be set afterwards.

The distance S may be set, for example, when the image processing system 1 (FIG. 1) is installed or at the time of maintenance performed by service personnel. Additionally, the distance S may be set when a user selects a copying mode.

User interface screens used to set the distance S will be described herein.

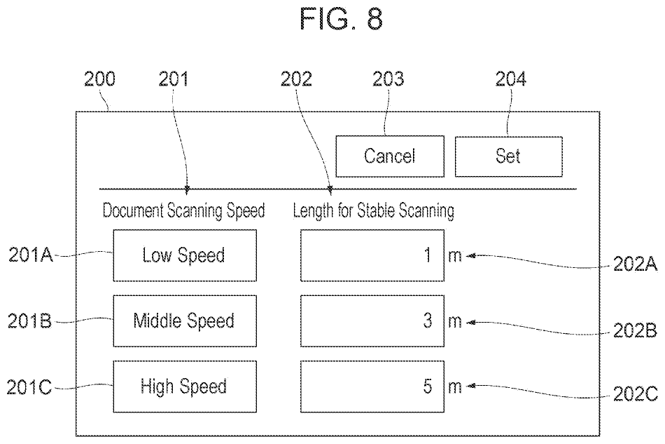

FIG. 8 is an illustration describing an example of a user interface screen 200 used to set the distance S for stabilizing document transport.

The user interface screen 200 depicted in FIG. 8 is displayed by the operation panel 15 (refer to FIG. 1).

In the present exemplary embodiment, the user interface screen 200 is displayed by the operation panel 15 when a copying condition is set.

The user interface screen 200 in FIG. 8 is composed of a section for the document transport speed 201, a section for specifying the distance S for stabilizing document transport 202, a “Cancel” button 203, and a “Set” button 204.

The section for the document transport speed 201 is entitled “Document Scanning Speed”. In FIG. 8, the section for the document transport speed 201 includes a “Low Speed” box 201A, a “Middle Speed” box 201B, and a “High Speed” box 201C. Namely, the speeds are classified into three categories.

The section for specifying the distance S for stabilizing document transport 202 is entitled “Length for Stable Scanning”. In FIG. 8, the section for specifying the distance S for stabilizing document transport 202 includes three boxes each of which corresponds to a transport speed of a document.

In FIG. 8, a figure “1” is displayed in an input box 202A corresponding to the “Low Speed” box 201A. This indicates that the distance S for stabilizing document transport is 1 m. A figure “3” is displayed in an input box 202B corresponding to the “Middle Speed” box 201B. This indicates that the distance S for stabilizing document transport is 3 m. A figure “5” is displayed in an input box 202C corresponding to the “High Speed” box 201C. This indicates that the distance S for stabilizing document transport is 5 m.

These figures for the distance S may be provided as initial values, settings previously used, or values newly entered or modified by the user.

As the transport speed of a document increases, the distance S for stabilizing document transport increases. This is because a document during transport becomes likely to skew from the transport direction and document jamming becomes relatively likely to occur as the transport speed increases.

If the speed represented by “High Speed” is assumed to be an example of a first speed, the speed that is represented by “Middle Speed” or “Low Speed” and that is lower than the speed represented by “High Speed” is an example of a second speed. If the speed represented by “Middle Speed” is assumed to be an example of a first speed, the speed represented by “Low Speed” is an example of a second speed.

If the “Cancel” button 203 is operated, a figure entered by a user or service personnel is canceled and the figure returns to the previous one. Alternatively, the figure may return to a value entered as an initial value prior to shipment from the factory.

If the “Set” button 204 is operated, the entry by a user or service personnel is fixed, and the entered value may be referred to in step 3 (refer to FIG. 5).

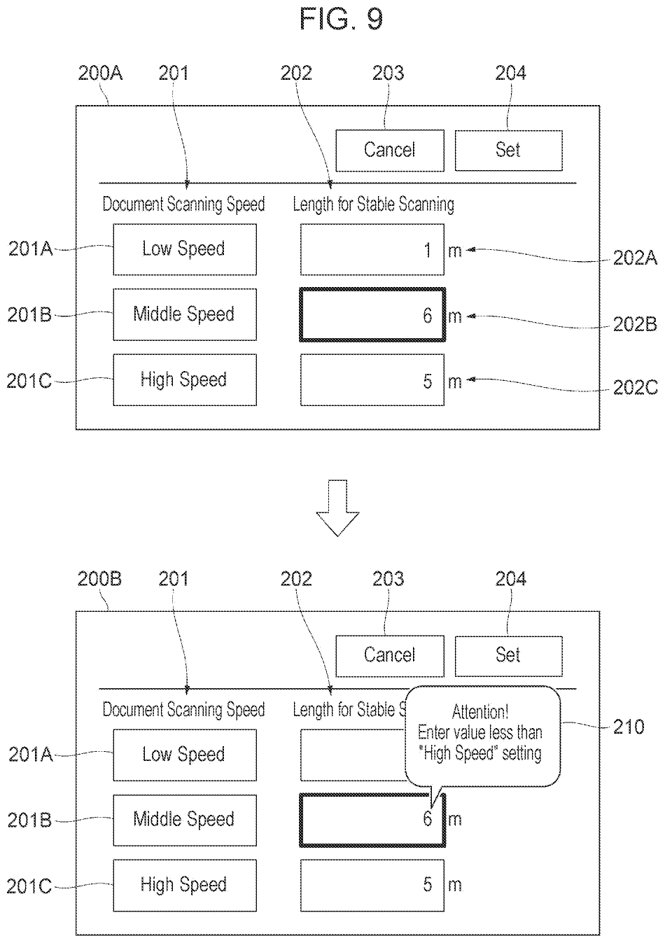

FIG. 9 is an illustration describing a change in the user interface screen 200 (refer to FIG. 5) that appears when the distance S for stabilizing document transport is inappropriately specified. The same symbols are used in FIGS. 8 and 9 to refer to corresponding portions and features.

FIG. 9 depicts display examples of a user interface screen 200A that appears immediately after an inappropriate figure has been entered and a user interface screen 200B that appears to correct the entered figure.

In the user interface screen 200A, a figure “6” is displayed in the input box 202B corresponding to the “Middle Speed” box 201B. The value is larger than “5” in the input box 202C corresponding to the “High Speed” box 201C as well as larger than “1” in the input box 202A corresponding to the “Low Speed” box 201A.

However, document jamming is more likely to occur for “High Speed” than for “Middle Speed”. Thus, a value smaller than the value in the input box 202C corresponding to the “High Speed” box 201C needs to be entered into the input box 202B corresponding to the “Middle Speed” box 201B.

Thus, the user interface screen 200B displays a pop-up 210 associated with the input box 202B to alert the user.

The pop-up 210 depicted in FIG. 9 reads “Attention!” and “Enter value less than ‘High Speed’ setting”.

The display and the sentences of the pop-up 210 are an example, and the user may be notified of a value inappropriately entered by various methods including the refusal to accept an inappropriately entered value, the output of an alarm sound from a loudspeaker not depicted, and the input box 202B or the user interface screen 200A blinking.

### Summarization

Since the distance S for stabilizing document transport may be set in the present exemplary embodiment, setting or adjusting the distance S is easy.

The distance S for stabilizing document transport may be set separately for each transport speed of a document in the present exemplary embodiment.

Helping the user to enter the setting of the distance S based on the transport speed is also possible in the present exemplary embodiment.

A sheet is less likely to be wasted because the distance S is set based on the transport speed of a document in the present exemplary embodiment.

### Third Exemplary Embodiment

In the present exemplary embodiment, the image processing system 1 described with reference to FIG. 1 is also assumed. A processor 11 (refer to FIG. 1) used in the present exemplary embodiment also has the functional configuration depicted in FIG. 2.

However, an image processing system 1 according to the present exemplary embodiment has a function of setting the distance S for stabilizing document transport based on the history of document jamming in the past. Specifically, the distance S may be set based on the history of document jamming recorded for each user in the present exemplary embodiment.

For example, document jamming may be more likely to occur when some users use the image processing system 1 and less likely to occur when other users use the image processing system 1. Such a situation occurs, for example, when some users properly insert a document and some other users tend to insert a document in a skew direction.

In some cases, a transport distance likely to cause document jamming may be identified based on the size of a document to be copied.

Thus, a distance S for stabilizing transport is set based on the information regarding the history of document jamming in the present exemplary embodiment.

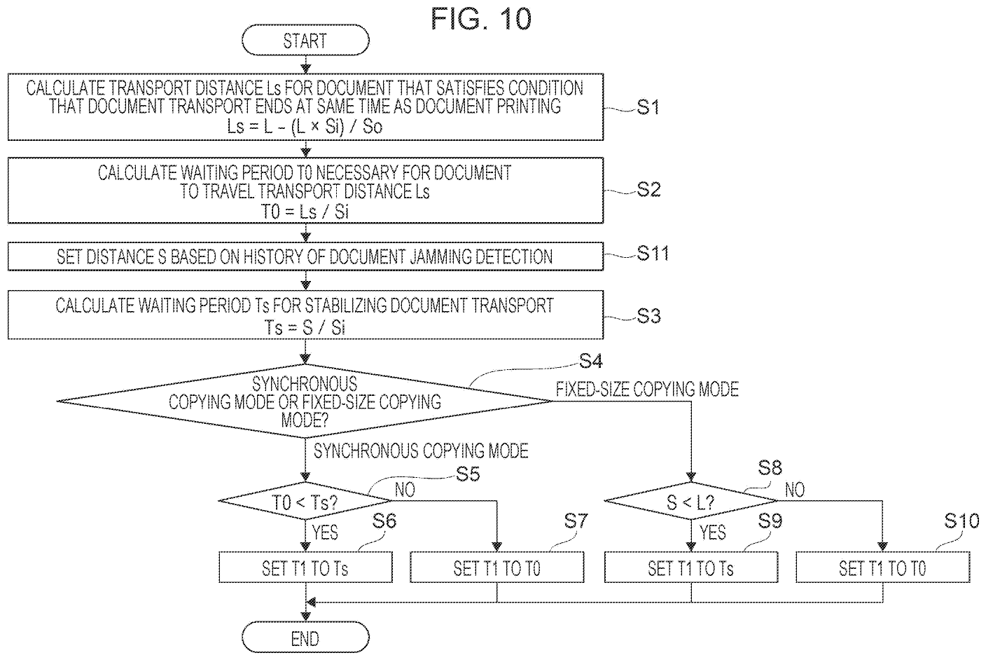

FIG. 10 is a flowchart for describing an example of a processing operation performed by the image processing system 1 (refer to FIG. 1) when a user instructs the image processing system 1 to perform copying. The same symbols are used in FIGS. 5 and 10 to refer to corresponding portions and features.

FIG. 10 differs in that there is step 11 between step 2 and step 3 to set the distance S based on the history of document jamming detection.

The history herein is recorded for each user who uses the present image processing system 1.

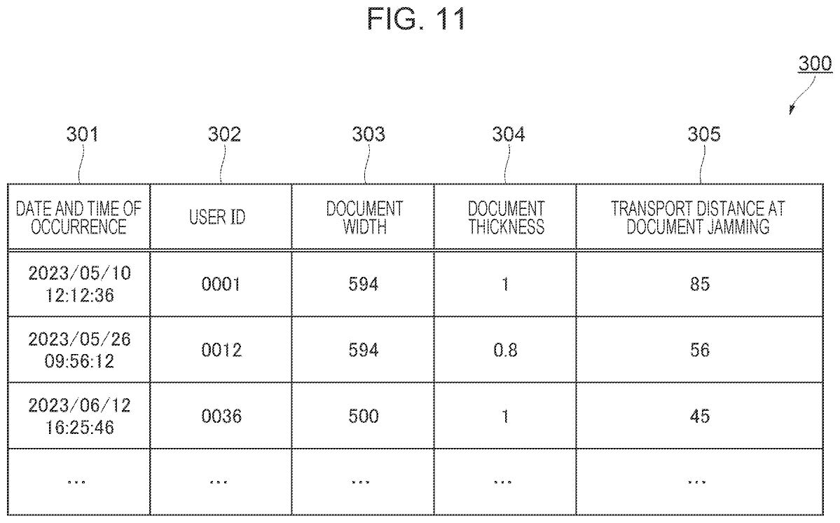

FIG. 11 is an illustration describing an example of a database 300 that has collected histories of document jamming that occurred in the past.

The database 300 depicted in FIG. 11 is composed of entries for a date and time of occurrence 301, a user ID 302, a document width 303, a document thickness 304, and a transport distance at which document jamming occurred 305.

It is to be noted that a document having a narrower width is more likely to cause document jamming than a document having a greater width. It is also to be noted that a thinner document is more likely to cause document jamming than a thicker document.

Thus, the document width 303 and the document thickness 304 are both recorded in the database 300 in the present exemplary embodiment.

Information recorded in the database 300 is not limited to the above items or may be some of the above items.

A user who has never caused document jamming is distinguishable from a user who has caused document jamming in the past based on the database 300 depicted in FIG. 11.

For example, for a user who has never caused document jamming, the distance S for stabilizing document transport may be set to the initial value that has been set, for example, prior to shipment from the factory.

Alternatively, the maximum or average value of the transport distances at which document jamming occurred may be identified for documents having a width and thickness both similar to the width and thickness of the document to be copied, and the distance S for stabilizing document transport may be set to the identified maximum or average value.

In contrast, for a user who has caused document jamming in the past, the maximum or average value of the transport distances at which the user caused document jamming in the past may be identified, and the distance S for stabilizing document transport may be set to the identified maximum or average value.

To calculate the maximum or average value, transport distances at which document jamming occurred may be extracted and used for documents having a width and thickness both similar to the width and thickness of the document to be copied.

Even for a user who has caused document jamming in the past, the maximum or average value of the transport distances at which document jamming occurred may be identified regardless of the users for documents having a width and thickness both similar to the width and thickness of the document to be copied, and the distance S for stabilizing document transport may be set to the identified maximum or average value.

If the distance S for stabilizing document transport is set in step 11, the processor 11 performs a process similar to the process in the first exemplary embodiment described above.

### Summarization

Since the distance S for stabilizing document transport is set based on the history of document jamming that occurred in the past in the present exemplary embodiment, the history of document jamming may be accommodated in setting a threshold. Further, a threshold may be set based on the width and thickness of a document. As a result, the amount of sheet wasted due to document jamming is reduced.

### Other Exemplary Embodiments

(1) The exemplary embodiments of the present disclosure have been described as above, but the technical scope of the present disclosure is not limited to the range described in the exemplary embodiments above. It is apparent from the description in the claims that various modifications and improvements made to the exemplary embodiments described above do not depart from the technical scope of the present disclosure.

(2) In the second exemplary embodiment described above, the description has been given with regard to the case where the distance S may be specified for each category of the transport speed, but the distance S may be set regardless of the transport speed of a document.

(3) In the second exemplary embodiment described above, the description has been given with regard to the case where the distance S may be specified for each of the three categories of the transport speed, but two categories or four or more categories may be defined for the transport speed, and the distance S may be specified for each of the two categories or for each of the four or more categories. Additionally, if the transport speed of a document may be set to any value in a predetermined range, the distance S may individually be specified for the transport speed that is set.

(4) In the second exemplary embodiment described above, the description has been given with regard to the case where the distance S is set for each category of the transport speed. However, the distance S may also be set based on the thickness of a document as well as the transport speed. In such a case, thicknesses may be classified into multiple categories, and the distance S may be set for each category of the thickness.

It is to be noted that a thinner document is more likely to cause document jamming than a thicker document. Thus, the distance S for a thinner document is greater than the distance S for a thicker document. Accordingly, if the distance S is set to a smaller value for a category of a relatively smaller thickness than for a category of a greater thickness, a message such as the pop-up 210 (refer to FIG. 9) may be displayed.

(5) In the second exemplary embodiment described above, the description has been given with regard to the case where the distance S is set for each category of the transport speed. However, the distance S may also be set based on the width of a document as well as the transport speed. In such a case, widths may be classified into multiple categories, and the distance S may be set for each category of the width.

It is to be noted that a wider document is more likely to cause document jamming than a narrower document. Thus, the distance S for a wider document is greater than the distance S for a narrower document. Accordingly, if the distance S is set to a smaller value for a category of a relatively greater width than for a category of a narrower width, a message such as the pop-up 210 (refer to FIG. 9) may be displayed.

(6) The description has been given with regard to the case where the distance S for stabilizing document transport is used as the threshold to determine the time to start document transport (that is, start printing) in the exemplary embodiments described above, but the waiting period Ts corresponding to the distance S may be used.

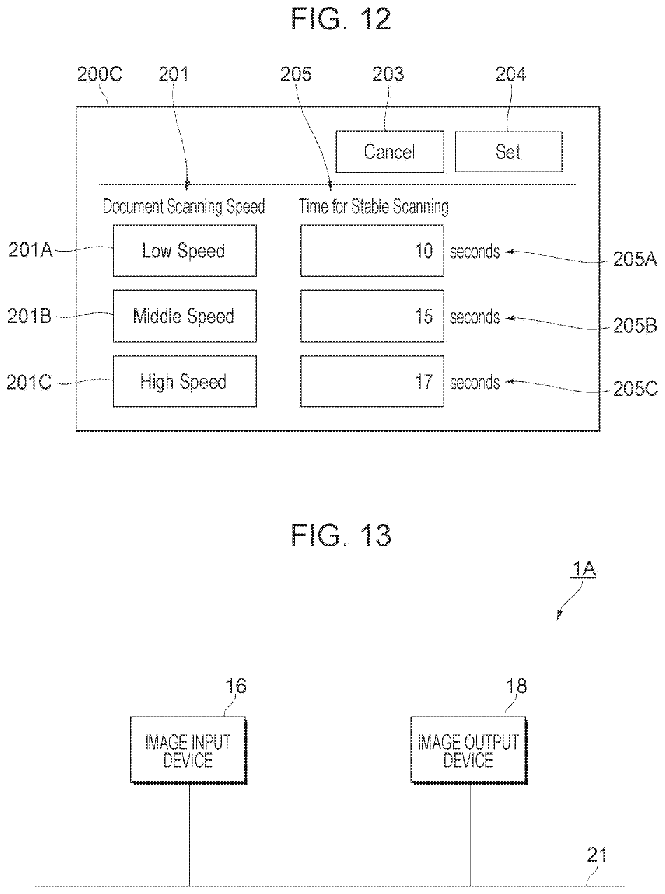

FIG. 12 is an illustration describing an example of a user interface screen 200C used to set the waiting period Ts for stabilizing document transport. The same symbols are used in FIGS. 8 and 12 to refer to corresponding portions and features.

The user interface screen 200C depicted in FIG. 12 is also displayed by the operation panel 15 (refer to FIG. 1).

For example, the user interface screen 200C is displayed by the operation panel 15 when a copying condition is set.

The user interface screen 200C in FIG. 12 is composed of a section for the document transport speed 201, a section for specifying the waiting period Ts for stabilizing document transport 205, a “Cancel” button 203, and a “Set” button 204.

In FIG. 12, the section for specifying the waiting period Ts for stabilizing document transport 205 is entitled “Time for Stable Scanning”. In FIG. 12, the section for specifying the period Ts for stabilizing document transport 205 includes three boxes each of which corresponds to a transport speed of a document.

In FIG. 12, a figure “10” is displayed in an input box 205A corresponding to the “Low Speed” box 201A. This indicates that the waiting period Ts for stabilizing document transport is 10 seconds. A figure “15” is displayed in an input box 205B corresponding to the “Middle Speed” box 201B. This indicates that the waiting period Ts for stabilizing document transport is 15 seconds. A figure “17” is displayed in an input box 205C corresponding to the “High Speed” box 201C. This indicates that the waiting period Ts for stabilizing document transport is 17 seconds.

These figures for the waiting period Ts may be provided as initial values, settings previously used, or values newly entered or modified by the user.

As the transport speed of a document increases, the waiting period Ts for stabilizing document transport increases. This is because a document during transport becomes likely to skew from the transport direction and document jamming becomes relatively likely to occur as the transport speed increases.

(7) In the third exemplary embodiment described above, the description has been given with regard to the example in which the distance S for stabilizing document transport is set by using the history of document jamming for documents having a width and thickness both similar to the width and thickness of the document to be copied, but the distance S for stabilizing document transport may be set by using history of document jamming for documents having a width or thickness similar to the width or thickness of the document to be copied.

(8) In the third exemplary embodiment described above, the description has been given with regard to the case where the transport distances at which document jamming occurred are recorded in the database 300, but the time that passed after the start of document transport until the occurrence of document jamming may be recorded in the database 300. In this case, the waiting period before starting sheet transport or the distance S for stabilizing document transport may be set based on the history of the time that passed. The waiting period herein is an example of an elapsed time.

(9) In the third exemplary embodiment described above, the description has been given with regard to the case where the distance S for stabilizing document transport is set based on the history of document jamming collected for the present image processing system 1, but the distance S for stabilizing document transport may be set by using history of document jamming that is collected for multiple image processing systems 1 and that is recorded in a server or other devices on the network. In other words, history of document jamming collected as big data may be used.

Additionally, the distance S for stabilizing document transport or the waiting period Ts may be used that is determined, for example, by the analysis of big data based on a combination of the size of a document and the transport speed.

(10) In the exemplary embodiments described above, it is assumed that the image processing system 1 (refer to FIG. 1) is integrally equipped with the image input device 16 (refer to FIG. 1) and the image output device 18 (refer to FIG. 1), but the image input device 16 and the image output device 18 may be provided as separated devices. In other words, the image input device 16 may be a so-called stand-alone scanner.

FIG. 13 is an illustration describing an example of a system configuration of an image processing system 1A according to another exemplary embodiment. The same symbols are used in FIGS. 1 and 13 to refer to corresponding units.

In the image processing system 1A depicted in FIG. 13, the processor of the image input device 16 and the processor of the image output device 18 may perform the processing operation described above in collaboration, the processor of the image input device 16 alone may perform the processing operation described above, or the processor of the image output device 18 alone may perform the processing operation described above.

Alternatively, the processor of a print server installed on a network 21 may perform the processing operation described above as the image input device 16 and the image output device 18 do in collaboration.

(11) In the exemplary embodiments described above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments described above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image processing system comprising one or more processors configured to, when a document as a scanning target travels and concurrently an image of the document being scanned in is formed on a medium, issue an instruction to start formation of the image on the medium after a transport distance traveled by the document or an elapsed time exceeds a threshold after scanning of the document starts, the threshold being set as a distance or a period for stabilizing transport of the document.

(((2)))

The image processing system according to (((1))), wherein the one or more processors are configured to accept a setting for the threshold via a screen operation.

(((3)))

The image processing system according to (((2))), wherein the one or more processors are configured to accept the setting for the threshold for each speed to be used to transport the document as a scanning target.

(((4)))

The image processing system according to (((3))), wherein the one or more processors are configured to accept the setting in such a manner that the threshold for a first speed is greater than the threshold for a second speed lower than the first speed.

(((5))

The image processing system according to any one of (((1))) to (((4))), wherein the one or more processors are configured to set the threshold based on a history of the transport distance or a history of the elapsed time, the transport distance and the elapsed time being recorded at a time of detection of document jamming.

(((6)))

The image processing system according to (((5))), wherein the one or more processors are configured to set the threshold based on the history corresponding to one of a width and a thickness of the document as a scanning target.

(((7)))

The image processing system according to any one of (((1))) to (((6))), wherein the one or more processors are configured to change a setting for the threshold in response to a specification of a transport speed of the document as a scanning target.

(((8)))

The image processing system according to any one of (((1))) to (((7))), wherein the one or more processors are configured to, if the threshold is less than a transport distance traveled by the document or an elapsed time when the transport distance or the elapsed time satisfies a condition that the scanning of the document ends at the same time as the formation of the image ends, use the transport distance traveled by the document or the elapsed time that satisfies the condition, as a time to start the formation of the image on the medium.

(((9)))

The image processing system according to any one of (((1))) to (((8))), wherein the one or more processors are configured to, upon forming the image of the document on a medium having a specified size, if the threshold is less than a transport distance traveled by the document or an elapsed time when the transport distance or the elapsed time satisfies a condition that the scanning of the document ends at the same time as the formation of the image ends, use the transport distance traveled by the document or the elapsed time that satisfies the condition, as a time to start the formation of the image on the medium.

(((10)))

The image processing system according to any one of (((1))) to (((9))), wherein the one or more processors are configured to, upon forming the image of the document on a medium having a specified size, if the threshold is more than a transport distance traveled by the document or an elapsed time when the transport distance or the elapsed time satisfies a condition that the scanning of the document ends at the same time as the formation of the image ends, issue an instruction to start the formation of the image on the medium after the transport distance traveled by the document or the elapsed time exceeds the threshold after the scanning of the document starts.

(((11)))

A program causing a computer to execute a process, the process comprising, when a document as a scanning target travels and concurrently an image of the document being scanned in is formed on a medium, issuing an instruction to start formation of the image on the medium after a transport distance traveled by the document or an elapsed time exceeds a threshold after scanning of the document starts, the threshold being set as a distance or a period for stabilizing transport of the document.

What is claimed is:

1. An image processing system comprising:
one or more processors configured to:
when a document as a scanning target travels and concurrently an image of the document being scanned in is formed on a medium,
issue an instruction to start formation of the image on the medium after a transport distance traveled by the document or an elapsed time exceeds a threshold after scanning of the document starts, the threshold being set as a distance or a period for stabilizing transport of the document.

2. The image processing system according to claim 1,
wherein the one or more processors are configured to:
accept a setting for the threshold via a screen operation.

3. The image processing system according to claim 2,
wherein the one or more processors are configured to:
accept the setting for the threshold for each speed to be used to transport the document as a scanning target.

4. The image processing system according to claim 3,
wherein the one or more processors are configured to:
accept the setting in such a manner that the threshold for a first speed is greater than the threshold for a second speed lower than the first speed.

5. The image processing system according to claim 1,
wherein the one or more processors are configured to:
set the threshold based on a history of the transport distance or a history of the elapsed time, the transport distance and the elapsed time being recorded at a time of detection of document jamming.

6. The image processing system according to claim 5,
wherein the one or more processors are configured to:
set the threshold based on the history corresponding to one of a width and a thickness of the document as a scanning target.

7. The image processing system according to claim 1,
wherein the one or more processors are configured to:
change a setting for the threshold in response to a specification of a transport speed of the document as a scanning target.

8. The image processing system according to claim 1,
wherein the one or more processors are configured to:
if the threshold is less than a transport distance traveled by the document or an elapsed time when the transport distance or the elapsed time satisfies a condition that the scanning of the document ends at the same time as the formation of the image ends, use the transport distance traveled by the document or the elapsed time that satisfies the condition, as a time to start the formation of the image on the medium.

9. The image processing system according to claim 1,
wherein the one or more processors are configured to:
upon forming the image of the document on a medium having a specified size, if the threshold is less than a transport distance traveled by the document or an elapsed time when the transport distance or the elapsed time satisfies a condition that the scanning of the document ends at the same time as the formation of the image ends, use the transport distance traveled by the document or the elapsed time that satisfies the condition, as a time to start the formation of the image on the medium.

10. The image processing system according to claim 1,
wherein the one or more processors are configured to:
upon forming the image of the document on a medium having a specified size, if the threshold is more than a transport distance traveled by the document or an elapsed time when the transport distance or the elapsed time satisfies a condition that the scanning of the document ends at the same time as the formation of the image ends, issue an instruction to start the formation of the image on the medium after the transport distance traveled by the document or the elapsed time exceeds the threshold after the scanning of the document starts.

11. A non-transitory computer readable medium storing a program causing a computer to execute a process, the process comprising:
when a document as a scanning target travels and concurrently an image of the document being scanned in is formed on a medium,
issuing an instruction to start formation of the image on the medium after a transport distance traveled by the document or an elapsed time exceeds a threshold after scanning of the document starts, the threshold being set as a distance or a period for stabilizing transport of the document.

12. An image processing method comprising:
when a document as a scanning target travels and concurrently an image of the document being scanned in is formed on a medium,
issuing an instruction to start formation of the image on the medium after a transport distance traveled by the document or an elapsed time exceeds a threshold after scanning of the document starts, the threshold being set as a distance or a period for stabilizing transport of the document.
